(19) United States
(12) Patent Application Publication
(10) Pub. No.: US 2022/0242676 A1
(43) Pub. Date: Aug. 4, 2022

(54) TEST OBJECT AND DIAGNOSIS SYSTEM AND GOODS INSPECTION DEVICE USING SUCH OBJECT

(71) Applicant: ANRITSU CORPORATION, Kanagawa (JP)

(72) Inventors: Junichi TAMURA, Kanagawa (JP); Hirotaka ANZAI, Kanagawa (JP); Hitoshi KOMIYAMA, Kanagawa (JP)

(73) Assignee: ANRITSU CORPORATION, Kanagawa (JP)

(21) Appl. No.: 17/612,069

(22) PCT Filed: May 18, 2020
(86) PCT No.: PCT/JP2020/019636

§ 371 Date: Nov. 17, 2021

(30) Foreign Application Priority Data
May 22, 2019 (JP) 2019-096121
Jul. 17, 2019 (JP) 2019-131978

(51) Int. Cl. B65G 43/00; G01P 13/00; G01P 15/18; G01P 3/00; H04W 4/38

(52) U.S. Cl. CPC B65G 43/00; G01P 13/00; B65G 2203/0208; G01P 3/00; H04W 4/38; G01P 15/18

(57) ABSTRACT

[Problem]

There is provided a goods inspection device making it possible to make a diagnosis easily for inspection function failure caused by dynamic behavior of goods attributed to a conveyance subsystem of an inspection line.

[Solution]

The goods inspection device 1 that inspects goods being carried on an inspection line includes a diagnosis unit 25c that diagnoses a conveyance subsystem of the inspection line, based on data of acceleration and angular velocity obtained with respect to respective axial directions from a test object 2 when the test object 2 having a motion sensor 12 to detect acceleration and angular velocity with respect to respective directions of three-dimensional axes is carried.

### TECHNICAL FIELD

The present invention relates to a test object that is used for a diagnosis of conveyance subsystems of goods inspection device that inspects goods being carried on an inspection line by a conveying device and the inspection line and also relates to a diagnosis system and a goods inspection device using it.

### BACKGROUND ART

As goods inspection device that inspects goods being carried on an inspection line by a conveying device, for example, a metal detector and an X-ray foreign matter detector to detect foreign matters in goods and a weight sorter to sort goods by weight are heretofore known.

By the way, for the goods inspection device of this kind, work to verify the operation of the goods inspection device using test objects is performed before carrying out inspection of goods in order to reduce misdetection and keep detection accuracy. A foreign matter detector using test pieces is disclosed, e.g., in Patent Literature 1 mentioned below.

A test piece as per Patent Literature 1 in which a foreign object piece for test is housed in a housing member includes an information registering unit in which identification information to identify the foreign object piece for test has been registered as optically readable information. In the foreign matter detector as per Patent Literature 1, while a conveying device carries test pieces on an inspection line, identification information is optically read from each test piece. Based on the read identification information, each test piece is identified and the detector operation is verified according to results of such identification.

As test objects conventionally used for verifying the operation of goods inspection device in the way as noted above, there have been test objects, each including a foreign matter having a predetermined size (a foreign object piece for test as disclosed in Patent Literature 1) or each having a predetermined weight.

### CITATION LIST

### Patent Literature

Patent Literature 1: Japanese Unexamined Patent Application Publication No. 2010-107357

### SUMMARY OF INVENTION

### Technical Problem

However, among test objects used in conventional goods inspection device, there has been no test object equipped with a sensor in itself. For that reason, as for inspection function failure attributed to dynamic behavior of goods being carried, e.g., when the goods are transferred from one conveyor to another, a skilled serviceman has to diagnose and adjust a conveyance subsystem of the goods inspection device in an actual production site. The following problem remained: it is not possible to make a diagnosis easily for inspection function failure caused by dynamic behavior of goods attributed to a conveyance subsystem of the goods inspection device. Here, the conveyance subsystem means mechanism sections involved in carrying goods within an inspection line (a series of device components including the goods inspection device and the conveying devices disposed upstream and downstream of the goods inspection device).

Therefore, the present invention has been developed in view of the problem noted above and has an object of providing a test object making it possible to make a diagnosis easily for inspection function failure caused by dynamic behavior of goods attributed to a conveyance subsystem of an inspection line and also providing a diagnosis system and a goods inspection device using it.

### Solution to Problem

To achieve the foregoing object, a test object described in claim 1 of the present invention is as follows: for use to diagnose a conveyance subsystem of a goods inspection device 1 that inspects goods carried by a conveyor unit 21, a test object 2 that is carried by the conveyor unit, the test object comprising:

a motion sensor 12 to detect acceleration and angular velocity with respect to respective directions of three-dimensional axes;

an embracing member 11 to embrace the motion sensor; and

an external interface unit 15 for outputting data including the acceleration and the angular velocity to outside.

The test object described in claim 2 is the test object of claim 1 further comprising a storage unit 14 to store the data, wherein the external interface unit 15 outputs data in the storage unit at predetermined timing.

The test object described in claim 3 is the test object of claim 1 or 2, wherein the external interface unit 15 outputs the data to outside by radio transmission.

The test object described in claim 4 is the test object of any of claims 1 to 3 further comprising an environmental diagnostic sensor 13, wherein the external interface unit 15 outputs data obtained by the environmental diagnostic sensor to outside.

A diagnosis system described in claim 5 comprises:

a test object 2 of any of claims 1 to 4; and

a diagnosis device 5 that acquires data output by the test object and diagnoses the conveyance subsystem of the goods inspection device 1 that has carried the test object, based on the created diagnostic data in time series obtained with respect to the respective directions of the three-dimensional axes.

The diagnosis system described in claim 6 is the diagnosis system of claim 5, wherein the diagnosis device 5 creates waveforms from the diagnostic data.

A goods inspection device described in claim 7 is as follows: a goods inspection device 1 that inspects goods being carried on an inspection line, comprising:

a data acquisition unit 25a that acquires data of acceleration and angular velocity obtained with respect to the respective directions of the axes from the test object when the test object 2 described in any of claims 1 to 4 is carried on the inspection line; and

a diagnosis unit 25c that diagnoses a conveyance subsystem of the inspection line based on the data.

The goods inspection device described in claim 8 is the goods inspection device of claim 7, wherein the data acquisition unit 25a acquires the data stored in a storage unit 14 comprised in the test object 2 via a medium.

The goods inspection device described in claim 9 is the goods inspection device of claim 7, wherein the data acquisition unit 25a acquires the data from a communication unit 15 comprised in the test object 2 via radio transmission.

The goods inspection device described in claim 10 is the goods inspection device of any of claims 7 to 9 further comprising a conveyor unit 21 to carry the goods, wherein the diagnosis unit 25c judges whether or not a deviation in the data for a period of time when the test object is transferred between the conveyor unit and a section of the conveying device 3 disposed upstream or downstream of the conveyor unit falls within a predefined range.

The goods inspection device described in claim 11 is the goods inspection device of any of claims 7 to 9, wherein the diagnosis unit 25c judges whether or not a deviation in the data in an inspection region obtained when a masterwork with the motion sensor 12 installed therein is carried as the test object 2 falls within a predefined range.

The goods inspection device described in claim 12 is the goods inspection device of any of claims 7 to 9, wherein the diagnosis unit 25c includes a storage unit 25b to store diagnosis results and is provided with a predictive maintenance function for monitoring transition of diagnosis results stored in the storage unit and presuming performance degradation or deterioration.

### Advantageous Effects of Invention

According to the present invention, it is possible to make a diagnosis easily for inspection function failure caused by dynamic behavior of goods attributed to a conveyance subsystem of an inspection line or goods inspection device.

### BRIEF DESCRIPTION OF DRAWINGS

FIG. 1 is a block diagram depicting an outlined configuration of a goods inspection device pertaining to the present invention.

FIG. 2 is a block diagram depicting outlined configurations of a test object and a diagnosis system pertaining to the present invention.

FIG. 3A is an outlined perspective view of a test object carried by a conveying device toward the goods inspection device pertaining to the present invention.

FIG. 3B is a block diagram depicting an outlined configuration of a test object.

FIG. 4 is a diagram to explain respective axes of a test object on the conveying device.

FIG. 5A is a diagram illustrating an example in which a packaging product is an object to be inspected.

FIG. 5B is a diagram illustrating an example of an embracing member adapted for the object to be inspected in FIG. 5A.

FIG. 5C is a diagram illustrating an example in which a container product is an object to be inspected.

FIG. 5D is a diagram illustrating an example of an embracing member adapted for the object to be inspected in FIG. 5C.

FIG. 6A is an explanatory diagram as a side view of an example of transferring a test object between conveying devices on the inspection line.

FIG. 6B is an explanatory diagram as a plan view of an example of transferring a test object between conveying devices on the inspection line.

FIG. 7A is a waveform illustrating an example of a rotational angle change per unit time with respect to a Y axis direction.

FIG. 7B is a waveform illustrating an example of a rotation angle change per unit time with respect to a Z axis direction.

FIG. 8A is a diagram illustrating a state of carrying a test object in an X-ray inspection device without shield curtains.

FIG. 8B is a diagram illustrating a state of carrying a test object in an X-ray inspection device with shield curtains.

FIG. 9 is a diagram illustrating an example of a waveform of acceleration in the direction of carrying a test object in FIG. 8B.

FIG. 10 is a diagram illustrating an example of a waveform of carriage speed obtained from the acceleration waveform of FIG. 9.

FIG. 11 is a diagram illustrating examples of a target transit time and an actual transit time to move a target carriage distance with regard to a test object carried in FIG. 8B.

FIG. 12 is a diagram to explain a case where carriage speed of a test object falls with a permissible range.

FIG. 13 is a diagram to explain a case where carriage speed of a test object is out of a permissible range.

FIG. 14 is a diagram illustrating an example of a change in acceleration with respect to a Z axis direction.

FIG. 15 is a diagram illustrating an example of a change in angular velocity with respect to a pitch axis direction.

FIG. 16 is a diagram to explain a case where a test object with a motion sensor installed to the object to be inspected is carried by the conveying device.

FIG. 17 is a diagram representing an example of tilt detection data detected to correct data with respect to respective axial directions of a test object with a motion sensor installed to the object to be inspected.

### MODE FOR CARRYING OUT INVENTION

In the following, embodiments for carrying out the present invention are described in detail with reference to the accompanying drawings.

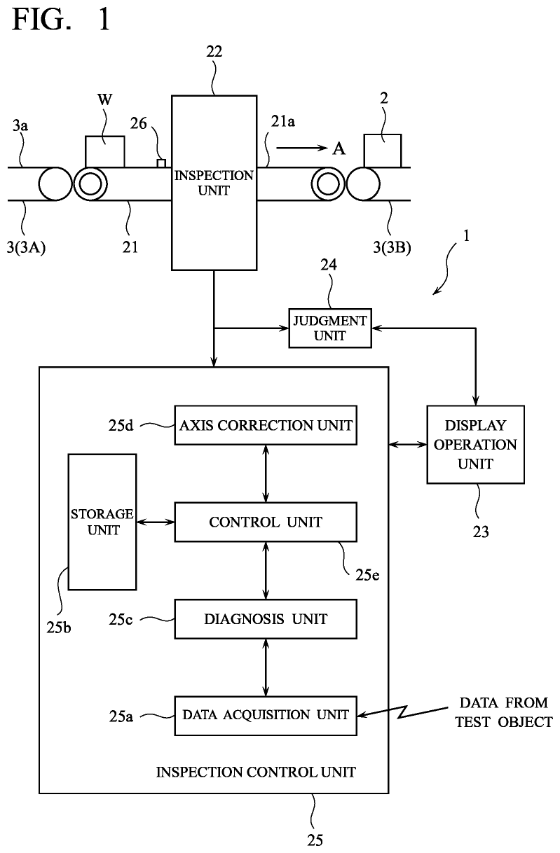

As is depicted in FIG. 1, a goods inspection device 1 of the present embodiment is configured as, e.g., a metal detector, a foreign matter detector using X-ray, or a weight sorter that inspects goods (objects to be inspected) being carried from upstream of an inspection line and has functionality for acquiring data from test objects 2 and diagnosing a conveyance subsystem of the inspection line.

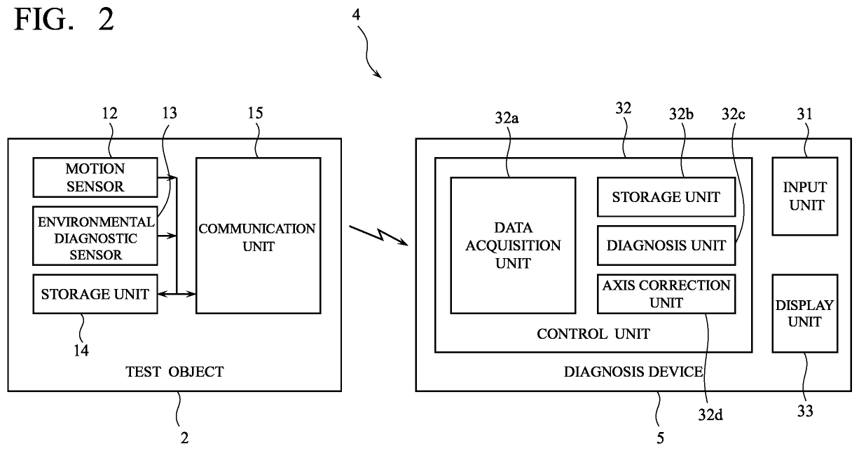

Also, as is depicted in FIG. 2, a diagnosis system 4 of the present embodiment is generally configured including a test object 2 that is used in the goods inspection device 1 (such as, e.g., a metal detector, a foreign matter detector using X-ray, or a weight sorter) and a diagnosis device 5 that acquires data from test objects 2 and diagnoses the conveyance subsystem of the inspection line in which the goods inspection device 1 is situated. For the test object 2, the goods inspection device 1, and the diagnosis device 5, their configurations are described below.

[Test Object Configuration]

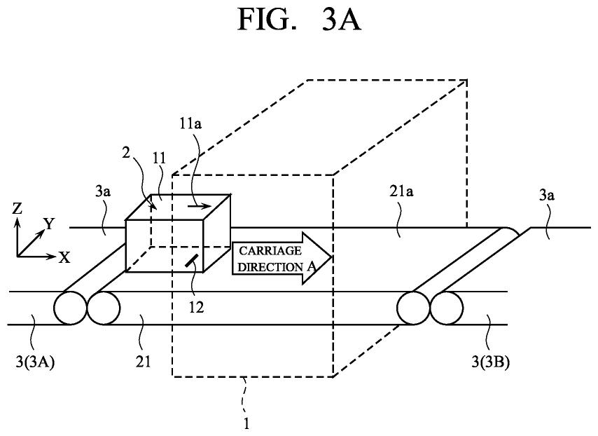

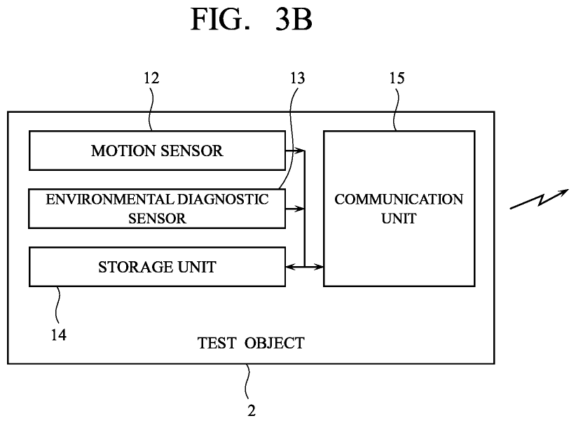

Test objects 2 are used when a diagnosis is performed for the conveyance subsystem of the inspection line in which the goods inspection device 1 that inspects objects to be inspected (goods) is situated, such as, e.g., a metal detector, a foreign matter detector using X-ray, or a weight sorter, and a conveyance subsystem of the goods inspection device 1. A test object 2 has an embracing member 11 whose bottom contacts the carrying surface 3a of conveying device 3 such as, e.g., a belt conveyor to carry goods on the inspection line toward the goods inspection device 1 when diagnosing the conveyance subsystem of the inspection line, as is depicted in FIG. 3A, and a motion sensor 12, an environmental diagnostic sensor 13, a storage unit 14, and a communication unit 15 as in FIG. 3B are housed.

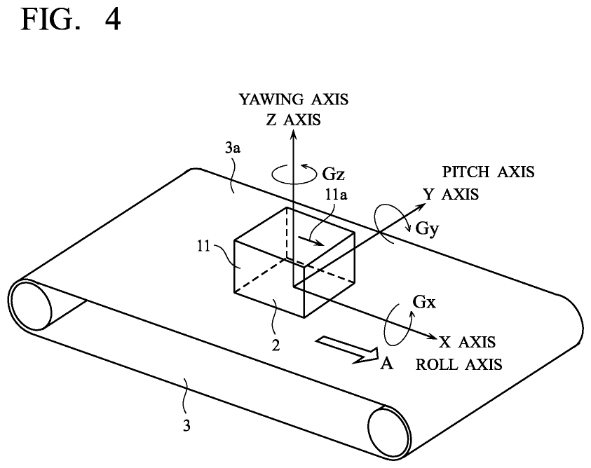

One surface of the embracing member 11 has an identifier 11a including, e.g., an arrow mark attached onto it, as is depicted in FIG. 3A and FIG. 4, so that the test object 2 will be carried in normal orientation. To set the test object 2 in normal orientation, the object is placed on the carrying surface 3a of the conveying device 3 with its surface having the identifier 11a up, aligning the arrow mark of the identifier 11a with a carriage direction A. This prevents the test object 2 from being carried in an incorrect direction on the carrying surface 3a of the conveying device 3 when a user makes a diagnosis using test objects 2.

Note that it is preferable to make the embracing member 11 in a shape and with a material analogous to structural and physical characteristics of objects to be inspected (goods) which are subject to inspection.

The structural and physical characteristics are, for example, as follows: the position of the center of gravity and its degree of freedom, mechanical stability, the shape and area of the base face that contacts the carrying surface 3a of conveying device 3, hardness of the base face, a coefficient of friction of the base face, etc.

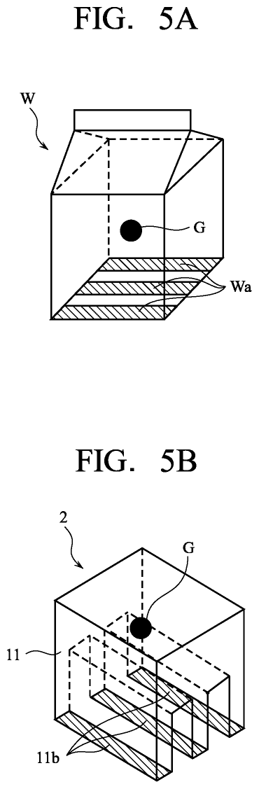

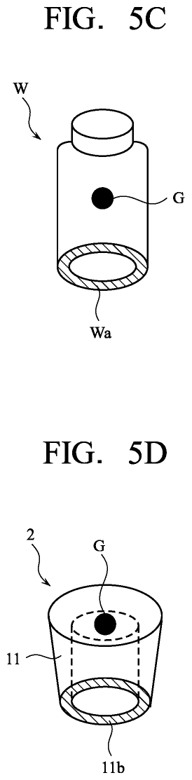

Specifically, for example, if a packaging product, as is illustrated in FIG. 5A, is an object W to be inspected, the embracing member 11 formed as is illustrated in FIG. 5B is used. The embracing member 11 of FIG. 5B is made of metal or resin and formed substantially in a rectangular parallelepiped shape in which gravity G is positioned at a height equivalent to the object W to be inspected in FIG. 5A and the bottom is notched to form the base face 11b (shaded portions in the drawing) having the same shape and area as the base face Wa (shaded portions in the drawing) of the object W to be inspected that contacts the carrying surface 3a of the conveying device 3.

In addition, for example, if a container product, as is illustrated in FIG. 5C, is an object W to be inspected, the embracing member 11 formed as is illustrated in FIG. 5D is used. The embracing member 11 of FIG. 5D is made of metal or resin and formed substantially in a columnar shape in which gravity G is positioned at a height equivalent to the position of the center of gravity in the object W to be inspected in FIG. 5C, and the bottom is notched to form the base face 11b (shaded portions in the drawing) having the same shape and area as the base face Wa (shaded portions in the drawing) of the object W to be inspected that contacts the carrying surface 3a of the conveying device 3.

Note that an object W to be inspected for which inspection is actually performed may be used as the embracing member 11 and a test object 2 may be configured with the motion sensor 12, the storage unit 14, and the communication unit 15 provided in the object W to be inspected. In addition, a masterwork whose representative properties such as dimensions, shape, and density are defined in accordance with an object W to be inspected for which inspection is actually performed may be used as the embracing member 11, and a test object 2 may be configured with the motion sensor 12, the storage unit 14, and the communication unit 15 provided in the masterwork. In that case, the environmental diagnostic sensor 13 may be provided as required.

The motion sensor 12 is comprised of a three-axis acceleration sensor and a three-axis angular velocity sensor and outputs six-axis data. The three-axis acceleration sensor detects acceleration with respect to each of the axis directions of an X axis (the carriage direction A of the carrying surface 3a), a Y axis (a direction perpendicular to the X axis of the carrying surface 3a), and a Z axis (a direction vertical to the carrying surface 3a) in FIG. 4. The three-axis angular velocity sensor detects angular velocity with respect to each of the axis directions of a roll axis (the carriage direction A of the carrying surface 3a), a pitch axis (a direction perpendicular to the X axis of the carrying surface 3a), and a yawing axis (a direction vertical to the carrying surface 3a) in FIG. 4. The motion sensor 12 outputs detected data as digitalized values of a voltage proportional to acceleration detected by the three-axis acceleration sensor and a voltage proportional to angular velocity detected by the three-axis angular velocity sensor.

The motion sensor 12 is situated in place inside the embracing member 11 according to the purpose of detection. For example, if the purpose is to detect an impact on goods when being transferred between conveyors, the motion sensor 12 is situated near to the bottom of the embracing member 11 in a position nearer to the carrying surface 3a of the conveying device 3. In that case, it is preferable to dispose the motion sensors 12 in multiple positions, i.e., the center and front, back, left and right with respect to the carriage direction A at a height near to the bottom of the embracing member 11.

If the purpose is to detect stability, the motion sensor 12 is situated in the vicinity of the gravity of the embracing member 11.

If the purpose is to detect shaking, the motion sensor 12 is situated near to the top surface of the embracing member 11. In that case, it is preferable to dispose the motion sensors 12 in multiple positions, i.e., the center and front, back, left and right with respect to the carriage direction A at a height near to the top surface of the embracing member 11.

The environmental diagnostic sensor 13 is a sensor that detects physical quantities in an ambient environment around the test object 2, including, e.g., temperature, humidity, air pressure, pressure, wind velocity, microphone (sound), magnetism, etc. For example, based on sound data, a diagnosis for abnormal sound during carriage can be performed. Data on air pressure and volume may also be applied to a diagnosis for a wind environment among others. One or more environmental diagnostic sensors 13 in combination are provided as required inside the embracing member 11. Data detected by the environmental diagnostic sensor(s) 13 is output as digitalized values of a voltage detected and output by each sensor.

Note that, if the environmental diagnostic sensors 13 can be provided in conjunction with the motion sensors 12 inside the embracing member 11, it is preferable to dispose them in optimal positions where desired information (such as, e.g., impact on goods when being transferred between conveyors, stability, or shaking) is obtained by the motion sensors 12; those positions are determined by experiment, etc.

The storage unit 14 acquires and stores data that is output by the motion sensor(s) 12 at a predetermined period (e.g., at intervals of 5 ms and at 200 Hz) and in time series and has a FIFO structure to store data for a predetermined period of time.

The storage unit 14 also stores data that is output by the environmental diagnostic sensor(s) 13 in correspondence with the time axis of data acquired from the motion sensor(s) 12.

The communication unit 15 as an external interface unit transfers data in the storage unit 14 together with information identifying the test object 2 itself to outside by radio at predetermined timing. The communication unit 15 enables specified low power radio for industrial use such as, e.g., the international radio communication standard “Wi-SUN (Wireless Smarty Utility Network)”, near field communication such as Bluetooth (registered trademark), and wireless LAN communication.

Note that the communication unit 15 may use wired communication according to one of various wired communication schemes via, e.g., a communication cable (USB cable) of the USB (Universal Serial Bus) standard to transfer data in the storage unit 14 in bulk or the data may be transferred via a medium such as a USB memory as the external interface unit.

In addition, storing and transferring data may be set to restart upon detecting carriage of the test object 2 (detecting acceleration in the X-axis direction (carriage direction A)) or, in a case where an operation switch is provided for the test object 2, may be carried out when the operation switch is turned ON (for restart).

[Goods Inspection Device Configuration]

As is depicted in FIG. 1, the goods inspection device 1 is generally configured including a conveyor unit 21, an inspection unit 22, a display operation unit 23, a judgment unit 24, and an inspection control unit 25.

The conveyor unit 21 serially carries goods of a kind that is set via the display operation unit 23 from among various kinds of goods, e.g., raw meat, fish, processed food, chemicals, etc. as objects W to be inspected; the conveyor unit is, for example, configured as a belt conveyor disposed horizontally with respect to the device body.

The conveyor unit 21 is driven by a motor which is not depicted, carries objects W to be inspected which have been carried in from an upstream section (3A) of the conveying device 3 on the carrying surface 21a in the arrow direction A (rightward, the carriage direction A) in FIG. 1 at a predetermined carriage speed which has been set beforehand, and carries them out to a downstream section (3B) of the conveying device 3.

As a signal indicating the state of each piece of the goods that are the objects W to be inspected, the inspection unit 22 outputs, a detection signal in accordance with the type and size of a foreign matter included in an object W to be inspected or a detection signal in accordance with the weight of an object W to be inspected.

To explain further, in a case where the goods inspection device 1 is configured as a metal detector, the inspection unit 22 is configured to generate an alternating magnetic field with a predetermined frequency and output a signal whose amplitude and phase change in response to a change in the magnetic field attributed to an object W to be inspected passing through the alternating magnetic field.

Note that the inspection unit may be configured such that metal included in an object W to be inspected is magnetized with a magnet or the like and residual magnetism of the magnetized metal is detected by a magnetic sensor.

In addition, in a case where the goods inspection device 1 is configured as X-ray inspection device, the inspection unit 22 is comprised of an X-ray source and an X-ray detector and configured as follows: when X-rays have been emitted from the X-ray source, the X-ray detector detects X-rays transmitted through an object W to be inspected, and the inspection unit 22 outputs a detection signal in accordance with its amount.

As components of the X-ray detector, for example, the following elements are used: multiple photo diodes arrayed in line in a direction orthogonal to the carriage direction A of objects W to be inspected which are carried by the conveyor unit 21; and line sensors provided with scintillators arranged in arrays over the photo diodes. In the X-ray detector as above, the scintillator receives X-rays transmitted through an object W to be inspected and converts the X-rays to light, and a photodiode situated thereunder converts the light to an electric signal which is in turn output. In other words, an electric signal in accordance with the amount of transmitted X-rays is output.

In addition, in a case where the goods inspection device 1 is configured as a weight measurement device, the inspection unit 22 is configured as follows: a part of the conveyor unit 21 is used as a weighing platform and a load sensor that is configured with a weighing mechanism such as an electromagnetic equilibrium mechanism is placed under the weighing platform; and the load sensor measures the load of an object W to be inspected placed on the weighing platform and outputs a signal in accordance with the load.

Note that the load sensor may apply any weighing mechanism that is capable of measuring weight and may be configured with a weighing mechanism such as, e.g., a differential transformer mechanism or a strain gauge mechanism.

At an upstream side of the inspection unit 22, a carry-in sensor 26 is provided to detect passage of an object W to be inspected being carried by the conveyor unit 21. The elements of the carry-in sensor 26 are each configured to serve as a transmissive photoelectric sensor comprised of a pair of a light projector and a light receiver, which are not depicted, disposed facing each other across the conveyor unit 21 in its width direction (a front to back direction in FIG. 1).

When an object W to be inspected passes between the respective light projector and light receiver of the carry-in sensor 26, light to be received by the light receiver is blocked by the object W to be inspected. Thus, the carry-in sensor 26 detects that the incoming object W to be inspected has passed to enter the inspection unit 22. A detection signal from the carry-in sensor 26 is output to the inspection control unit 25.

The display operation unit 23 is configured using a touch panel serving both an input operation function and a display function. As for input operation, the display operation unit 23 accepts a specified setting of what kind of objects W to be inspected will be carried by the conveyor unit 21 and various settings and commands regarding detection and measurement of a foreign matter included in the objects W to be inspected and operation check.

As for the display function, the display operation unit 23 displays various things including: a setting when specified about what kind of objects W to be inspected; a command when specified; various judgment results; discrete display and historical display of data relevant to test objects 2 obtained by their motion sensor(s) 12 and/or environmental diagnostic sensor(s) 13 and acquired by a data acquisition unit 25a; results and related graphs of a diagnosis by a diagnosis unit 25c; etc.

Note that the display operation unit 23 may be configured to be separated into the input operation function and the display function as independent ones. In this case, the display operation unit can be configured such that it is provided with multiple keys, switches, etc. for accepting settings, commands, etc. for the input operation function, and it is provided with a liquid crystal display or the like for the display function.

Based on a detection signal from the inspection unit 22, the judgment unit 24 makes a go/no go judgment as to whether or not a foreign matter is included in an object W to be inspected or whether or not the weight of an object W to be inspected falls within a predefined range, and causes the display operation unit 23 to display a screen including judgment results.

The inspection control unit 25 exerts overall control of the goods inspection device 1 and includes a data acquisition unit 25a, a storage unit 25b, a diagnosis unit 25c, an axis correction unit 25d, and a control unit 25e.

The data acquisition unit 25a acquires data that is output by radio from test objects 2, obtained by their motion sensor(s) 12 and/or environmental diagnostic sensor(s) 13, via a network such as wireless LAN.

Note that the data acquisition unit may directly acquire data from test objects 2 through near field communication such as Bluetooth (registered trademark) or specified low power radio for industrial use such as the international radio communication standard “Wi-SUN (Wireless Smarty Utility Network)” or a server or PC connected to the network may acquire such data and the data acquisition unit may acquire the data acquired there via a medium such as a USB memory. In addition, if the test objects 2 have a USB standard compliant port, the data acquisition unit may acquire data through the USB port of the test objects 2 through a cable or via a medium.

The storage unit 25b stores the following: various programs for the control unit 25e to control the goods inspection device 1; various parameters for the judgment unit 24 to make a go/no go judgment on objects W to be inspected; data relevant to test objects 2 obtained from their motion sensor(s) 12 and/or environmental diagnostic sensor(s) 13; diagnosis results, etc.

The diagnosis unit 25c diagnoses the conveyance subsystem of the inspection line, based on data relevant to test objects 2 obtained by their motion sensor(s) 12 and acquired by the data acquisition unit 25a (also referred to as diagnostic data). For instance, by comparing the measurements with respect to each axis taken by the motion sensor(s) 12 of a test object 2 against the corresponding standard values with respect to each axis measured in advance by the motion sensor(s) 12 under optimal set conditions, the diagnosis unit makes a diagnosis as to whether or not a proper adjustment is made of the heights of the carrying surfaces 3a, 21a of the conveying device 3 and the conveyor unit 21 and the gap (the gap between transition plates) between the conveying device 3 and the conveyor unit 21. Moreover, a test object 2 with the motion sensor(s) 12 (and the environmental diagnostic sensor(s) 13, as necessary) in a masterwork for inspecting the dimensions defined with respect to each model of the goods inspection device 1 installed is carried by the conveying device 3, and from the data obtained from the test object 2, the diagnosis unit derives the deviation from the standard (the peak value in a waveform) in an inspection region and makes a diagnosis as to whether or not the deviation falls within a predefined range; it also makes a pass/fail diagnosis by comparing the carriage characteristics with respect to each axis against the standard values. Note that concrete examples of a diagnosis by the diagnosis unit 25c will be described later.

In a case where data obtained by the environmental diagnostic sensor(s) 13 is included in data acquired by the data acquisition unit 25a, the diagnosis unit 25c makes a diagnosis about inspection accuracy and characteristics of the inspection unit 22 from the data obtained by the environmental diagnostic sensor(s) 13. Furthermore, the diagnosis unit 25c is also adapted to make a graphical representation of data (diagnostic data) relevant to test objects 2 obtained by their motion sensor(s) 12 and/or environmental diagnostic sensor(s) 13 and stored in time series in the storage unit 25b and generate a waveform indicating a temporal change of the data. Note that it is also possible to add diverse thresholds which are stored in the storage unit 25b to such a graphical representation. Displaying results and related graphs of a diagnosis by the diagnosis unit 25c on the display operation unit 23 allows the user to visually verify diagnosis results and related conditions.

The control unit 25e executes programs stored in the storage unit 25b and performs a parameter change for the judgment unit 24 and various control tasks for the goods inspection device 1.

Note that the axis correction unit 25d is a component that is necessary in a case where an object W to be inspected is used as the embracing member 11 and the object W to be inspected with the motion sensor(s) 12 installed therein afterwards is used as a test object 2, as will be described later; details of processing by this unit will be described afterwards.

[Diagnosis Device Configuration]

The diagnosis device 5 is configured using a personal computer equipped with a CPU and storage such as, e.g., RAM, ROM, and a hard disk device and adapted to implement various functions by executing pre-stored programs.

The diagnosis device 5 is a device that diagnoses the conveyance subsystem of the goods inspection device 1 through which a test object 2 has been carried, based on diagnostic data for a diagnosis, i.e., time-series data obtained with respect to each axis included in acquired data relevant to the test object 2. As is depicted in FIG. 2, the diagnosis device 5 is equipped with an input unit 31, a control unit 32, and a display unit 33.

The input unit 31 is configured with input devices including, e.g., a keyboard, a mouse, etc. A variety of information necessary for a diagnosis of the conveyance subsystem of the goods inspection device 1 is input and set through the input unit 31. Such information is, for example, as follows: carriage speed of the conveying device 3; a permissible range of carriage time; thresholds with respect to each axis (X axis, Y axis, Z axis) of acceleration to be detected by the motion sensor(s) 12 of a test object 2; thresholds with respect to each axis (roll axis, pitch axis, yawing axis) of angular velocity; thresholds of physical quantities (e.g., temperature, humidity, air pressure, pressure, wind velocity, microphone (sound), magnetism, etc.) to be detected by the environmental diagnostic sensor(s) 13 of a test object 2; etc.

The control unit 32 exerts integrated control of the diagnosis device 5 and includes a data acquisition unit 32a, a storage unit 32b, a diagnosis unit 32c, and an axis correction unit 32d.

The data acquisition unit 32a is connected to the network, communicates with test objects 2, and acquires data relevant to the test objects 2 obtained by their motion sensor(s) 12 and/or environmental diagnostic sensor(s) 13.

The storage unit 32b is configured using, e.g., a hard disk device or the like and stores data relevant to the test objects 2 obtained by their motion sensor(s) 12 and/or environmental diagnostic sensor(s) 13, which the data acquisition unit 32a has acquired. The storage unit 32b also stores the following: standard values and thresholds with respect to each axis (X axis, Y axis, Z axis, roll axis, pitch axis, yawing axis) of the motion sensor(s) 12; thresholds with respect to each of the physical quantities of the environmental diagnostic sensor(s) 13; formulae necessary to diagnose the conveyance subsystem of the goods inspection device 1; results of a diagnosis by the diagnosis unit 32c; etc.

The diagnosis unit 32c diagnoses the conveyance subsystem of the goods inspection device 1, based on data relevant to test objects 2 obtained by their motion sensor(s) 12 and environmental diagnostic sensor(s) 13 (such data is also referred to as diagnostic data), which has been stored in the storage unit 32b. For instance, by comparing the measurements with respect to each axis of the motion sensor(s) 12 of a test object 2 against the standard values with respect to each axis measured in advance of the motion sensor(s) 12 under optimal set conditions, the diagnosis unit makes a diagnosis as to whether or not a proper adjustment is made of the height of the carrying surface 3a of the conveying device 3 and the gap (the gap between transition plates) between the sections of the conveying device 3. Moreover, a test object 2 is prepared by installing the motion sensor(s) 12 (and the environmental diagnostic sensor(s) 13, as necessary) in a masterwork for inspecting the dimensions defined with respect to each model of the goods inspection device 1. The diagnosis unit makes a diagnosis as to whether or not data obtained by the sensor(s) in an inspection region, as the test object is carried by the conveying device 3, falls within a predefined range; it also makes a pass/fail diagnosis by comparing the carriage characteristics with respect to each axis against the standard values. Note that concrete examples of a diagnosis by the diagnosis unit 32c will be described later.

In addition, the diagnosis unit 32c is also adapted to make a graphical representation of data (diagnostic data) of the motion sensor(s) 12 and/or environmental diagnostic sensor(s) 13 of test objects 2 stored in time series in the storage unit 32b and generate a waveform indicating a temporal change of the data. Furthermore, it is also possible to add diverse thresholds which are stored in the storage unit 32b to such a graphical representation. Results and related graphs of a diagnosis by the diagnosis unit 32c are output to outside, as required. For example, outputting diagnosis results and related graphs to the goods inspection device 1 and displaying them on the display unit 33 allow the user to visually verify diagnosis results and related conditions.

Note that, as with the axis correction unit 25d in the goods inspection device 1, the axis correction unit 32d is a component that is necessary in a case where an object W to be inspected is used as the embracing member 11 and the object W to be inspected with the motion sensor(s) 12 installed therein afterwards is used as a test object 2; details of processing by this unit will be described afterwards.

The display unit 33 is configured using a display device such as, e.g., a liquid crystal display and displays the following: discrete display and historical display of data relevant to test objects 2 of their motion sensor(s) 12 and/or environmental diagnostic sensor(s) 13 acquired by the data acquisition unit 32a; results and related graphs of a diagnosis by the diagnosis unit 32c; etc.

[Diagnosis of Conveyance Subsystem]

When the goods inspection device 1 which is configured as described above is operated to diagnose the conveyance subsystem of the inspection line using test objects 2 or when the diagnosis system 4 is operated to diagnose the conveyance subsystem of the goods inspection device 1 using test objects 2, the test objects 2 prepared to correspond to the objects W to be inspected which are subject to inspection by the goods inspection device 1 are put on the carrying surface 3a of the conveying device 3 so as to be carried in the carriage direction A.

When putting each test object 2 on the carrying surface 3a of the conveying device 3, the test object 2 is placed on the carrying surface 3a of the conveying device 3 with its surface having the identifier 11a up, aligning the arrow mark of the identifier 11a with the carriage direction A, as depicted in FIG. 3A and FIG. 4.

As the test objects 2 are carried in the carriage direction A by the conveying device 3, the three-axis acceleration sensor of the motion sensor(s) 12 detects acceleration with respect to each of the X axis, Y axis, and Z axis directions in FIG. 4, and the three-axis angular velocity sensor detects angular velocity with respect to each of the roll axis, pitch axis, and yawing axis directions.

Additionally, in a case where the environmental diagnostic sensor(s) 13 are installed in the test object 2, the sensor(s) detect physical quantities in an ambient environment around the test object 2, including, e.g., temperature, humidity, air pressure, pressure, wind velocity, microphone (sound), magnetism, etc., as the test object is carried in the carriage direction A by the conveying device 3.

Then, the diagnosis unit 25c in the goods inspection device 1 or the diagnosis device 5 in the diagnosis system 4 acquires data relevant to the test objects 2 detected by their motion sensor(s) 12 and/or environmental diagnostic sensor(s) 13 through communication with the test object 2, analyses the acquired data, and diagnoses the conveyance subsystem.

[Concrete Examples of Diagnosis]

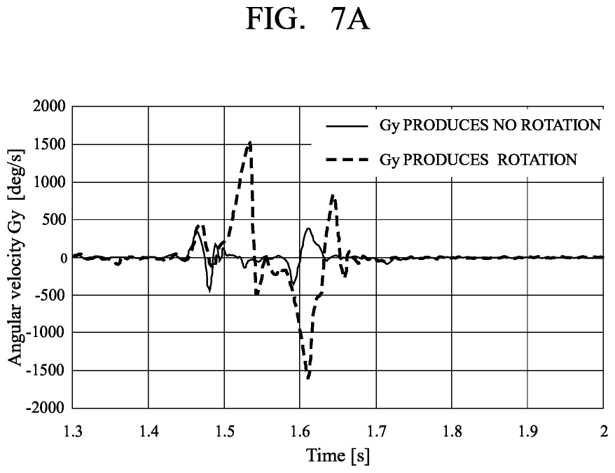

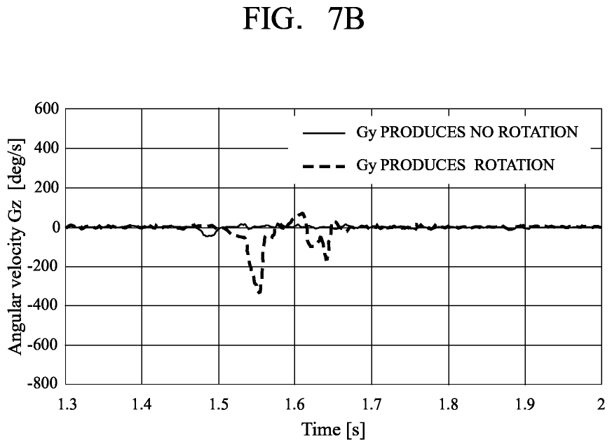

Then, descriptions are provided about Examples 1 to 3 as concrete examples of a diagnosis of the conveyance subsystem of the inspection line or the goods inspection device 1 using test objects 2. Note that, in the following description, the graphs of waveforms (FIG. 7 and FIGS. 9 through 15) generated from the diagnosis data by the diagnosis unit 25c in the goods inspection device 1 or the diagnosis unit 32c in the diagnosis device 5 are used for explanation.

### Example 1: Postural Change of Object when being Transferred Between Conveyors

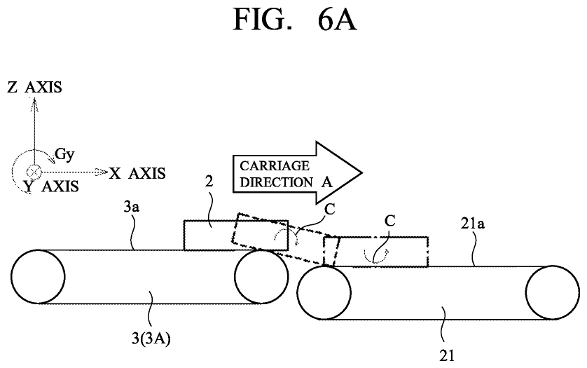

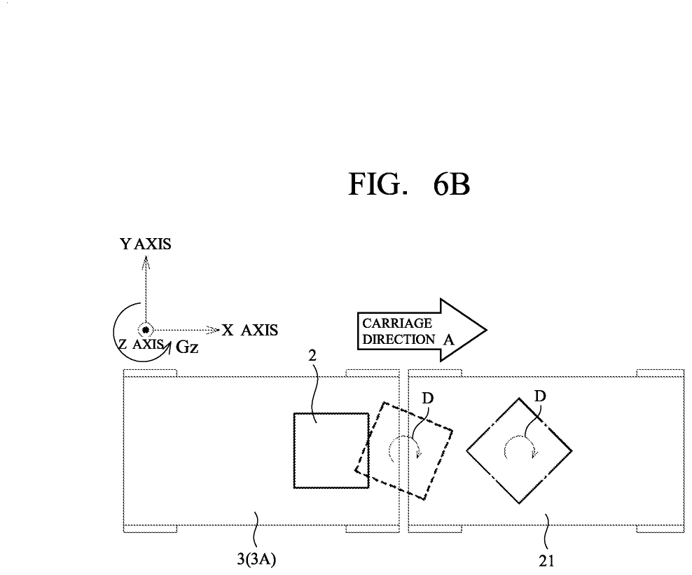

With the upstream section of the conveying device 3A and the downstream conveyor unit 21 of the goods inspection device 1 placed in line in the carriage direction A, as is depicted in FIG. 6A and FIG. 6B, descriptions are provided about a postural change of a test object 2 when being transferred between conveyors, when it is transferred from the conveying device 3A to the conveyor unit 21.

The goods inspection device 1 or the diagnosis device 5 judges whether there is a postural change of the object depending on whether or not, for a waveform for a period of time when the test sample is transferred from the conveying device 3A to the conveyor unit 21, its peak value (deviation) falls with a predefined range. Specifically, a change in angular velocity in the Y axis direction is observed from data detected by the motion sensor(s) 12 of the test object 2. If angular velocity Gy in the Y direction produces no rotation when the test object 2 is transferred from the conveying device 3A to the conveyor unit 21, this gives a waveform with small amplitude, as is drawn with a solid line in FIG. 7A. Therefore, a judgment is made that there is almost no postural change of the test object 2 due to rotation in the Y axis direction. In contract, if angular velocity Gy in the Y direction produces rotation when the test object 2 is transferred from the conveying device 3A to the conveyor unit 21, as indicated by an arrow C in FIG. 6A, this gives a waveform whose amplitude is larger than when angular velocity Gy in the Y direction produces no rotation, as is drawn with a dashed line in FIG. 7A. Therefore, a judgment is made that there is a postural change of the test object 2 due to rotation in the Y axis direction.

Also, the goods inspection device 1 or the diagnosis device 5 observes a change in angular velocity in the Z axis direction from data detected by the motion sensor(s) 12 of the test object 2. If angular velocity Gz in the Z direction produces no rotation when the test object 2 is transferred from the conveying device 3A to the conveyor unit 21, this gives a waveform with almost no change in amplitude, as is drawn with a solid line in FIG. 7B. Therefore, a judgment is made that there is almost no postural change of the test object 2 due to rotation in the Z axis direction. In contract, if angular velocity Gz in the Z direction produces rotation when the test object 2 is transferred from the conveying device 3A to the conveyor unit 21, this gives a waveform with a change in amplitude occurring for a moment when the test object 2 is transferred from the conveying device 3A to the conveyor unit 21, as is drawn with a dashed line in FIG. 7B. Therefore, a judgment is made that there is a postural change of the test object 2 due to rotation in the Z axis direction.

In this way, a diagnosis can be made about a postural change of the test objects 2 when they are transferred between the conveying device 3A and the conveyor unit 21 from data detected by the motion sensor(s) 12 of the test objects 2, i.e., from the magnitude of amplitude (deviation) of the waveforms reflecting rotation of angular velocity Gy in the Y axis direction and angular velocity Gz in the Z axis. Then, according to results of this diagnosis, it is possible to make a diagnosis for conditions of, e.g., tension of the conveyance belts of the conveying device 3A or the conveyor unit 21 and level adjustment of the conveyance belts of the conveying device 3A or the conveyor unit 21. This enables it to assist adjustment work when the goods inspection device 1 is installed or maintained.

### Example 2: Carriage Affected when Object Passes Shield Curtains of X-Ray Inspection Device

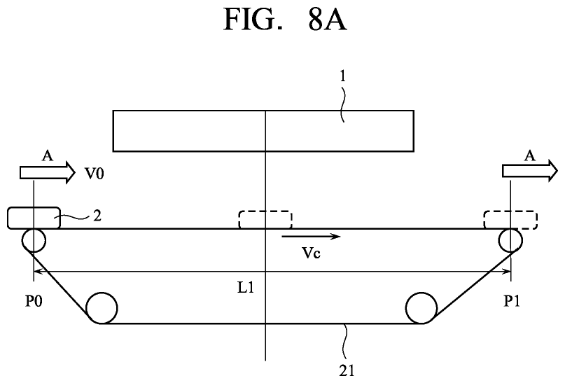

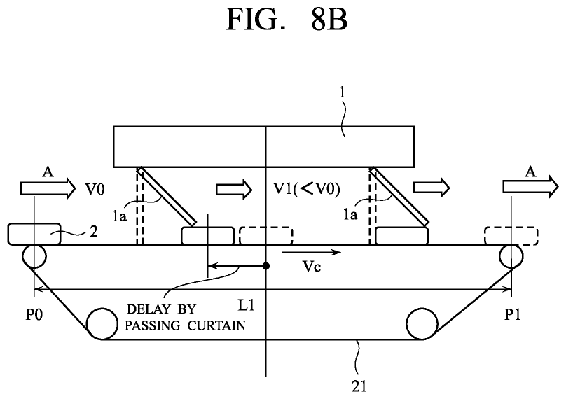

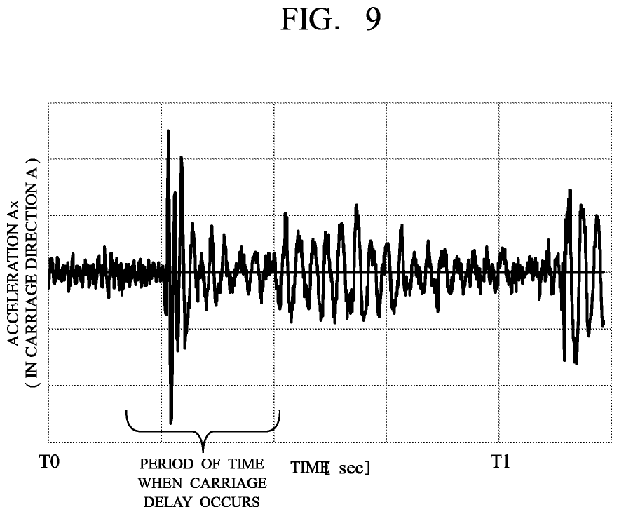

Carriage is affected by absence or presence of shield curtains 1a in an X-ray inspection device as the goods inspection device 1, as is depicted in FIG. 8A and FIG. 8B. These cases are described below.

In a case where there are no shield curtains 1a in the X-ray inspection device 1, as is depicted in FIG. 8A, a test object 2 that is present at an inlet P0 of the conveyor unit 21 is carried at constant velocity V0 in the carriage direction A up to an outlet P1 of the conveyor unit 21, as the conveyance belt of the conveyor unit 21 is driven at velocity Vc.

In contrast, in a case where there are shield curtains 1a in the X-ray inspection device 1, as is depicted in FIG. 8B, a test object 2 that is present at the inlet P0 of the conveyor unit 21 is carried at constant velocity V0 in the carriage direction A until it has arrived at a shield curtain 1a, as the conveyance belt of the conveyor unit 21 is driven at velocity Vc. However, the test object 2 receives resistance and slows down to velocity V1 (<V0) when it passes the shield curtain 1a and is carried up to the outlet P1 of the conveyor unit 21 at a speed delayed by passing the shield curtain 1a.

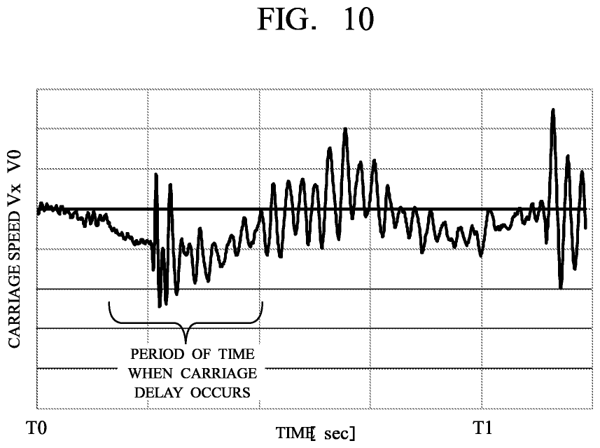

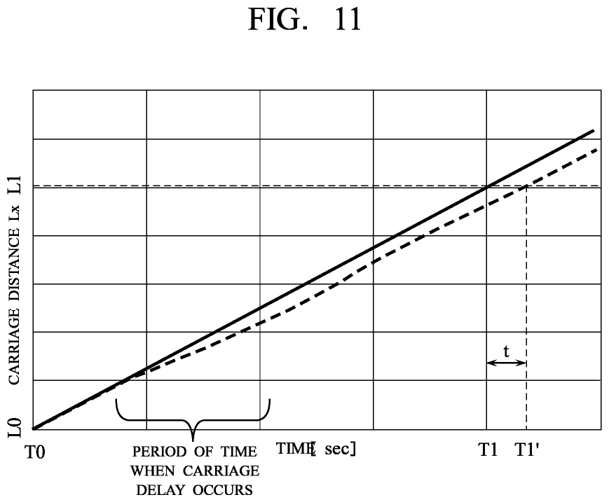

In the case where there are shield curtains 1a, the X-ray inspection device 1 or the diagnosis device 5 acquires data in which acceleration Ax of the test object fluctuates when moving in the carriage direction A, as is illustrated in FIG. 9, and computes the carriage speed of the test object 2 from integral acceleration (the area of the acceleration waveform) in the acquired data. The waveform of the carriage speed of the test object 2 thus computed (created) from the acceleration data in FIG. 9 is illustrated in FIG. 10.

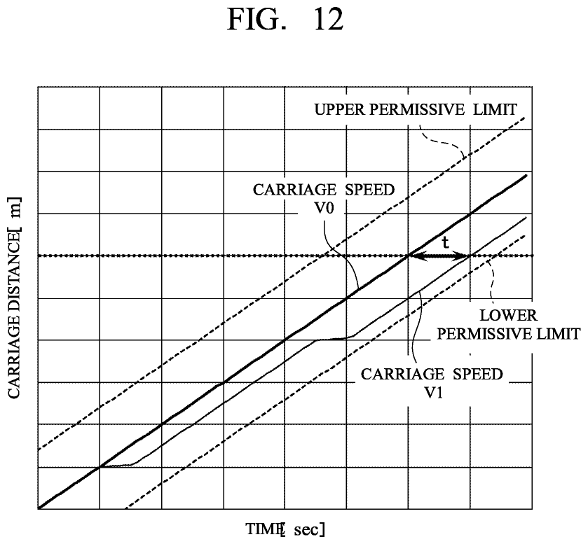

Then, from the carriage speed data of the test object 2 in FIG. 10, the X-ray inspection device 1 or the diagnosis device 5 computes carriage distance Lx for a period of time it takes for the test object 2 to move from the inlet P0 until it has arrived at the outlet P1, as is drawn with a dashed line in FIG. 11.

Here, when the test object 2 does not experience fluctuation of acceleration, T1 is obtained as the time it takes for the test object 2 to move over the distance from the inlet P0 of the conveyor unit 21 to the outlet P1 (carriage distance L1 in FIG. 11), as is drawn with a solid line in FIG. 11.

In contrast, when the test object 2 experiences fluctuation of acceleration, as illustrated in FIG. 9, the time it takes for the test object 2 to move over the distance from the inlet P0 of the conveyor unit 21 to the outlet P1 (carriage distance L1 in FIG. 11) is computed as T1′, as is drawn with a dashed line in FIG. 11; there occurs a delay time (deviation) t relative to the time T1 obtained when the test object 2 does not experience fluctuation of acceleration.

Then, if the delay time (deviation) t falls between upper and lower permissive limits (in a permissible range), as is illustrated in FIG. 12, the X-ray inspection device 1 or the diagnosis device 5 makes a diagnosis that the carriage delay (affected carriage) when the test object 2 passes the shield curtain 1a falls within the permissible range.

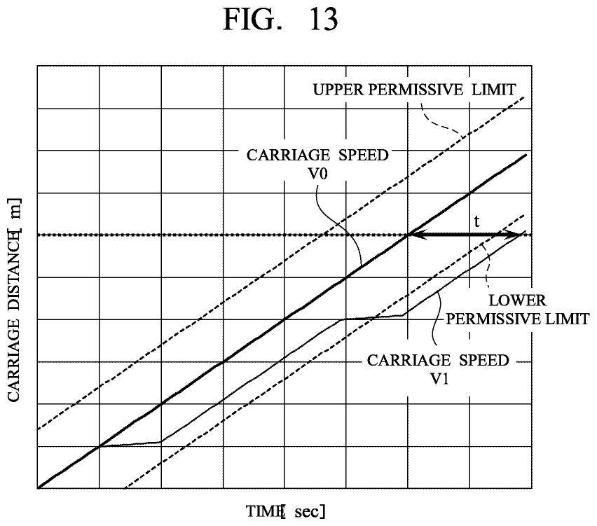

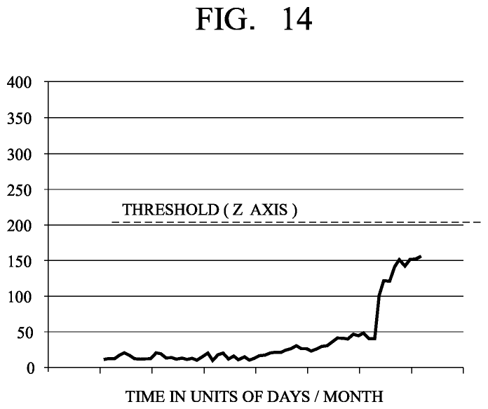

In contrast, if the delay time (deviation) t does not fall between upper and lower permissive limits (in a permissible range), as is illustrated in FIG. 13, the X-ray inspection device 1 or the diagnosis device 5 makes a diagnosis that the carriage delay (affected carriage) when the test object 2 passes the shield curtain 1a is out of the permissible range.

In this way, it is possible to compute an actual varying speed of the test object 2 relative to the target carriage speed V0, determine which section of the conveyor unit 21 causes the carriage delay (affected carriage), and make a diagnosis as to whether or not the carriage delay falls within a permissible range.

### Example 3: Predictive Maintenance

Descriptions are provided about periodical monitoring and predictive maintenance of the conveyance subsystem of the goods inspection device 1 using data from test objects 2.

The goods inspection device 1 or the diagnosis device 5 stores data relevant to test objects 2 acquired from their motion sensor(s) 12 and environmental diagnostic sensor(s) 13 and diagnosis results in the storage unit 25b, 32b and has a function of carrying out predictive maintenance based on the stored data and the diagnosis results.

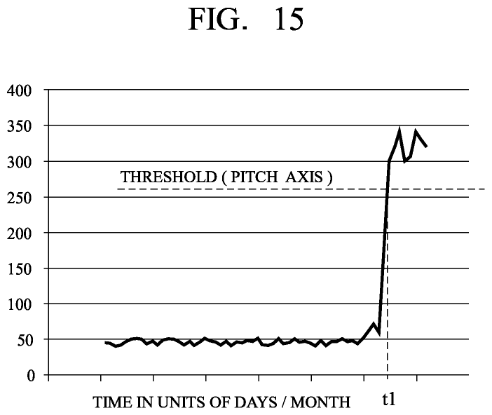

Specifically, tests of carrying test objects 2 are performed periodically at intervals of time in units of days/month and data relevant to the test objects 2 acquired from their motion sensor(s) 12 when the tests are performed is stored in the storage unit 25b, 32b. Then, the goods inspection device 1 reads out data of acceleration with respect to the Z axis direction in units of days/month from the data stored in the storage unit 25b, 32b and, as is illustrated in FIG. 14, displays history of acceleration with respect to the Z axis direction with its threshold (Z axis, a dashed line in the drawing) on the display operation unit 23 or the display unit 33. In the display example of FIG. 14, it is seen that acceleration with respect to the Z axis direction gradually increases and gets close to the threshold, as days/month passes.

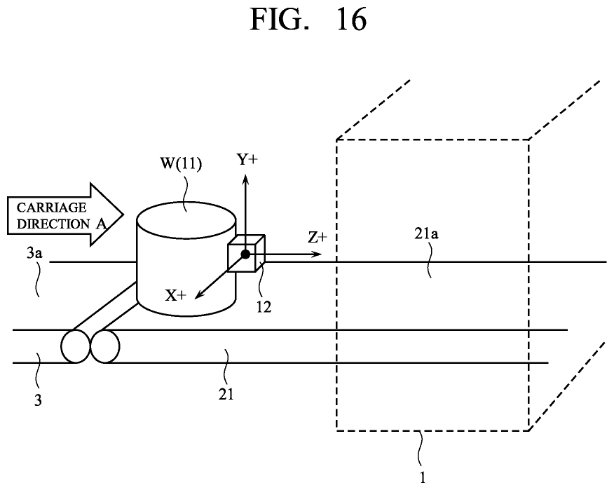

In addition, the goods inspection device 1 or the diagnosis device 5 reads out data of angular velocity with respect to the pitch axis direction obtained in units of days/month from the data stored in the storage unit 25b, 32b and, as is illustrated in FIG. 15, displays history of angular velocity with respect to the pitch axis direction with its threshold (pitch axis, a dashed line in the drawing) on the display operation unit 23 or the display unit 33. In the display example of FIG. 15, it is found that angular velocity with respect to the pitch axis direction increases with the result of days/month and has exceeded the threshold at a time of t1.

In this way, predictive maintenance can be carried out by monitoring transition of data relevant to test objects 2 obtained by their motion sensor(s) (and environmental diagnostic sensor(s) 13) and stored in the storage unit 25b, 32b and diagnosis results and, from monitoring results, by presuming performance degradation or deterioration attributed to the conveyance subsystem of the goods inspection device 1.

[Example of Modification]

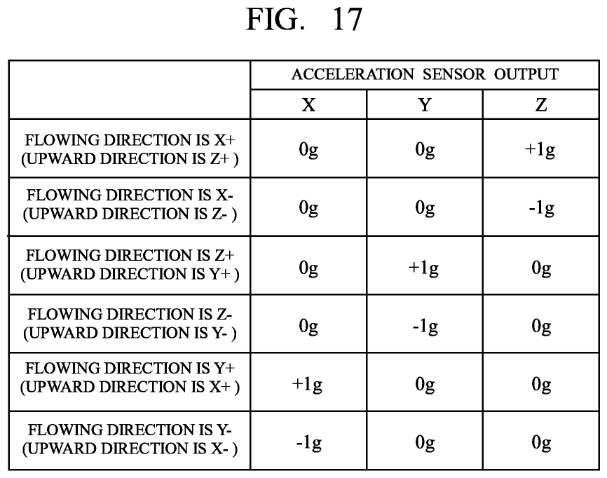

As an example of modification, as is depicted in FIG. 16, a test object 2 is configured in such a manner in which an object W to be inspected that is actually inspected is used as the embracing member 11 and a motion sensor unit in which a motion sensor 12 is integral with a communication unit 15 is externally installed (attached) to the object W to be inspected and secured to it. In a case where the goods inspection device 1 is a weight sorter, the use of this test object 2 enables it to make a diagnosis by measuring not only the flatness and level of the conveying device 3 and a weighing conveyor but also shaking of the object when being transferred between the conveying device 3 and the weighing conveyor and vibration and fluctuation with respect to each axis of the motion sensor 12, determining correlation with a weight waveform in terms of frequency, amplitude, and waveform shape, and also determining the proportion of how much the factors attributed to the object transfer affect the weighing accuracy.

However, when a diagnosis is performed with the test object 2 with the motion sensor 12 installed to the object W to be inspected, the respective axes of the motion sensor 12, as indicated in FIG. 16, differ from those defined with respect to the carrying surface 3a of the conveying device 3 and the carriage direction A in the case of the embracing member 11 that houses the motion sensor 12 in FIG. 3A. For this reason, the inspection control unit 25 of the goods inspection device 1 includes the axis correction unit 25d that modifies data obtained with respect to the directions of the respective axes from the test object 2 with the motion sensor 12 installed to the object W to be inspected to diagnostic data by correcting the respective directional axes. Likewise, the control unit 32 of the diagnosis device 5 includes the axis correction unit 32d that modifies data obtained with respect to the directions of the respective axes from the test object 2 with the motion sensor 12 installed to the object W to be inspected to diagnostic data by correcting the respective directional axes.

If the motion sensor 12 installed to the object W to be inspected detects a DC component and outputs data, the axis correction unit 25d, 32d identifies the orientation in which the motion sensor 12 is installed to the object W to be inspected and corrects the respective directional axes by making use of tilt detection data (data in FIG. 17) detected by the acceleration sensors (of a DC detection type) of the motion sensor 12 housed in the embracing member 11. In other words, after the motion sensor 12 is installed to the object W to be inspected, this correction involves detecting and correcting a gravitational acceleration component with the object placed on the carrying surface 3a of the conveying device 3 in a stop state. For example, given that the flowing direction of the test object 2 with the motion sensor 12 installed to the object W to be inspected is Z+ in FIG. 16, correction is made with a gravitational acceleration component of +1 g in the Y axis direction of the acceleration sensors, as given in the tilt detection data in FIG. 17.

In addition, if the motion sensor 12 installed to the object W to be inspected detects an AC component and outputs data, the axis correction unit 25d, 32d puts the motion sensor 12 for which sensed data is acquired beforehand in regular place on the carrying surface 3a of the conveying device 3 in a stop state. With respect to acceleration data in the X axis direction when the conveying device 3 is operated to run at a predetermined speed from the stop state, an X-Y angle and an X-Z angle are slightly shifted by a given angle; thus, acceleration data decomposed into three axes is obtained. In the acceleration data decomposed into three axes, the test object 2 with the motion sensor 12 attached to the object W to be inspected is put on the carrying surface 3a of the conveying device 3 in a stop state and the conveying device 3 is operated to run under the same carriage conditions. An X-Y angle and an X-Z angle at which acceleration data thus obtained with respect to the respective directions of the axes is the closest are determined as a correction amount, and the axes are corrected.

As described in the foregoing context, according to the present embodiment, by acquiring results (data) of sensing on test objects 2 having sensors (the motion sensor(s) 12 and/or environmental diagnostic sensor(s) 13) when they are carried, it is possible to make a diagnosis easily for inspection function failure caused by dynamic behavior of goods attributed to the conveyance subsystem of the inspection line or the conveyance subsystem of the goods inspection device 1. Also, by converting results of sensing obtained by the environmental diagnostic sensor(s) 13 to data, it is possible to analyze variation in stress (temperature, vibration, wind, sound, etc.) received by the goods inspection device 1 from its installation environment. Then, from the results of sensing, static and dynamic characteristics regarding inspection performance of the goods inspection device 1 can be verified and validated discretely.

In addition, the goods inspection device 1 analyzes data acquired from test objects 2 as diagnostic data, thereby making it possible to make a diagnosis for conditions of the conveyance subsystem of the goods inspection device 1 (the condition of adjustment of transfer between the conveying device 3 and conveyor unit 21, the condition of level adjustment of the conveying surface of conveyance belts), etc. This enables it to assist adjustment work when the goods inspection device 1 is installed or maintained.

Consequently, installation and adjustment can be performed correctly by even a person who is not a skilled serviceman and people with low skills about a device and its maintenance, such as users and maintenance staff of overseas agencies. Moreover, in the event of poor accuracy trouble, it is possible to identify a cause of degrading the accuracy and, therefore, an effect of reduced downtime can be expected.

By comparing results of checking for inspection performance using test objects 2 with actual production results, it is possible to find out variation in structural and physical characteristics of goods to be inspected that are actually produced.

In addition, the use of test objects 2 as masterworks for operation check makes it possible to check for changes in the conditions of carriage by the conveying device 3 and the conveyor unit 21 initially after they have been installed. Test objects 2 can be used to provide a predictive maintenance function in terms of detecting performance degradation or deterioration early.

Furthermore, when operation check is performed using test objects 2, a judgment that a test object 2 has been ejected as an NG work can be made from data of sensors (the motion sensor(s) 12 and/or environmental diagnostic sensor(s) 13) of the test objects 2. This makes it possible for the goods inspection device 1 to check whether or not a test object 2 has been ruled out, instead of being checked by a person; it would is to implement an unmanned line.

Additionally, space dedicated to store test objects 2 may be provided in the goods inspection device 1, so that the objects can be used as sensors for sensing installation environment characteristics (e.g., temperature, humidity, vibration, wind velocity, etc.) equipped in the goods inspection device 1 during operation.

The best mode embodiment of a test object and a diagnosis system and a goods inspection device using it pertaining to the present invention has been described hereinbefore; however, the description of this embodiment and the related drawings are not intended to limit the present invention. In other words, it is a matter of course that, based on this embodiment, other embodiments, operating techniques, etc. that may be carried out by those skilled in the art or the like are all included in the scope of the present invention.

### LIST OF REFERENCE SIGNS

1: goods inspection device
2: test object
(3A, 3B): conveying device
3a: carrying surface
4: diagnosis system
5: diagnosis device
11: embracing member
11a: identifier
11b: base face
12: motion sensor
13: environmental diagnostic sensor
14: storage unit
15: communication unit
21: conveyor unit
21a: carrying surface
22: storage unit
23: display operation unit
24: judgment unit
25: inspection control unit
25a: data acquisition unit
25b: storage unit
25c: diagnosis unit
25d: axis correction unit
25e: control unit
26: carry-in sensor
31: input unit
32: control unit
32a: data acquisition unit
32b: storage unit
32c: diagnosis unit
32d: axis correction unit
33: display unit
A: carriage direction
W: object to be inspected (goods)
Wa: base face
t: delay time

1. For use to diagnose a conveyance subsystem of a goods inspection device that inspects goods being carried by a conveyor unit, a test object that is carried by the conveyor unit, the test object comprising:
a motion sensor to detect acceleration and angular velocity with respect to respective directions of three-dimensional axes;
an embracing member to embrace the motion sensor; and
an external interface unit for outputting data including the acceleration and the angular velocity to outside.

2. The test object according to claim 1, further comprising a storage unit to store the data,
wherein the external interface unit outputs data in the storage unit at predetermined timing.

3. The test object according to claim 1, wherein the external interface unit outputs the data to outside by radio transmission.

4. The test object according to claim 1, further comprising an environmental diagnostic sensor,
wherein the external interface unit outputs data obtained by the environmental diagnostic sensor to outside.

5. A diagnosis system characterized by comprising:
the test object of claim 1; and
a diagnosis device that acquires data output by the test object and diagnoses the conveyance subsystem of the goods inspection device that has carried the test object, based on the created diagnostic data in time series obtained with respect to the respective directions of the three-dimensional axes.

6. The diagnosis system according to claim 5, wherein the diagnosis device creates waveforms from the diagnostic data.

7. A goods inspection device that inspects goods carried on an inspection line comprising:
a data acquisition unit that acquires data of acceleration and angular velocity obtained with respect to the respective directions of the axes from the test object when the test object described in claim 1 is carried on the inspection line; and
a diagnosis unit that diagnoses a conveyance subsystem of the inspection line based on the data.

8. The goods inspection device according to claim 7, wherein the data acquisition unit acquires the data stored in a storage unit comprised in the test object via a medium.

9. The goods inspection device according to claim 7, wherein the data acquisition unit acquires the data from a communication unit comprised in the test object via radio transmission.

10. The goods inspection device according to claim 7, further comprising a conveyor unit to carry the goods,
wherein the diagnosis unit judges whether or not a deviation in the data for a period of time when the test object is transferred between the conveyor unit and a section of the conveying device disposed upstream or downstream of the conveyor unit falls within a predefined range.

11. The goods inspection device according to claim 7, wherein the diagnosis unit judges whether or not a deviation in the data in an inspection region obtained when a masterwork with the motion sensor installed therein is carried as the test object falls within a predefined range.

12. The goods inspection device according to claim 7, wherein the diagnosis unit includes a storage unit to store diagnosis results and is provided with a predictive maintenance function for monitoring transition of diagnosis results stored in the storage unit and presuming performance degradation or deterioration.
